(19) United States
(12) Patent Application Publication
(10) Pub. No.: US 2004/0212568 A1
(43) Pub. Date: Oct. 28, 2004

(54) Plasma display panel driving method and apparatus, and plasma display apparatus

(76) Inventor: Kazuhiro Yamada, Osaka (JP)

Correspondence Address: SNELL & WILMER LLP, 1920 MAIN STREET, SUITE 1200, IRVINE, CA, 92614-7230, US

(21) Appl. No.: 10/491,318

(22) PCT Filed: Sep. 13, 2002
(86) PCT No.: PCT/JP02/09411

(30) Foreign Application Priority Data
Oct. 3, 2001 (JP) 2001-307249

(51) Int. Cl. G09G 3/28

(52) U.S. Cl. 345/63

(57) ABSTRACT

A plasma display panel driving method for displaying a gray-scale image by selecting, according to a luminance level of an input image signal, subfields from those making up one field in the time domain, and applying a voltage to a cell in a writing period and sustaining a state of the cell in a sustain period in the selected subfields. One field is divided into two subfield groups S and two subfield groups A. A time interval between respective starting or ending points of the subfield groups S is approximately one-half the length of one field. In each subfield group S, a light emitting state of OFF is continued until a writing is performed, after which ON is kept in each sustain period. In each subfield of the subfield groups A, a light emitting state of ON is set in a sustain period only when a writing is performed.

### TECHNICAL FIELD

The present invention relates to a method or apparatus for driving a plasma display panel that is used as a display for an information terminal, personal computer, or television, and also relates to a plasma display apparatus.

### BACKGROUND ART

In recent years, the plasma display panel has gained the spotlight as a large-screen, thin, and light display device that can be used for computers or televisions.

The plasma display panel achieves a color display by causing plasma discharges in a gas to generate ultraviolet rays and radiating phosphors (red, green, and blue) with the generated ultraviolet rays.

The plasma display panel is driven by a plasma display panel driving apparatus that controls the number of discharges for each subfield to provide a color gray-scale image display, where one frame of image is represented by one field, which is divided into a plurality of subfields in the time domain.

FIG. 1 shows the construction of the electrodes in a typical plasma display panel 100, and three driving circuits used for the gray-scale image display: a data driver 200; a scan driver 220; and a sustain driver 210.

The plasma display panel 100 includes a front glass substrate and a back glass substrate. A plurality of scan electrodes 101 and a plurality of sustain electrodes 102, both of which extend horizontally on the screen, are arranged on a surface of the front glass substrate, and a plurality of data electrodes 103, which extend vertically on the screen, are arranged on a surface of the back glass substrate.

The data driver 200 applies voltages selectively to the plurality of data electrodes 103. The scan driver 220 applies voltages selectively to the plurality of scan electrodes 101. The sustain driver 210 applies voltages all at once to the plurality of sustain electrodes 102.

The data electrodes 103 are arranged perpendicular to the scan electrodes 101 and sustain electrodes 102 which are arranged to be parallel to each other.

A cell 104, which is formed at an area near two intersections of a data electrode 103 and a pair of a scan electrode 101 and a sustain electrode 102, is the minimum unit in display.

Now, a plasma display panel driving method in which a gray scale display is achieved by dividing a field in the time domain into a plurality of subfields will be described.

FIG. 2 shows waveforms of voltages applied by a typical plasma display panel driving method to the scan electrodes 101, sustain electrodes 102, and data electrodes 103.

The following describes the procedure of voltage application in one subfield.

An erase pulse 301 is applied to the sustain electrodes 102 to erase the electrical charge accumulated in the dielectric covering each electrode (Erasure Process).

A period in a subfield in which the erasure process is performed is called an erasure period.

A high-voltage initialization pulse 302 is then applied to the scan electrodes 101 to cause discharge (hereinafter referred to as initialization discharge) in all cells in the panel, accumulating negative charge in the dielectric covering the scan electrodes 101 and accumulating positive charge in the dielectric covering the data electrodes (Initialization Process).

A period in a subfield in which the initialization process is performed is called an initialization period.

In the initialization process, space charge is generated evenly all over the panel by the initialization discharge. The evenly generated space charge works as a pilot and facilitates the generation of write discharge that is performed in the next writing process.

The initialization process also allows the electrical charge accumulated in the dielectric covering the scan electrodes 101 and data electrodes to act effectively, reducing the amplitude of the scan pulse and data pulse to be applied in the next writing process.

Negative-polarity scan pulses 303 are then sequentially applied to the scan electrodes 101. At the same time, positive-polarity data pulses 304 are applied to certain ones of the data electrodes 103. These operations in combination cause write discharge in cells at intersections of the electrodes.

The certain data electrodes 103 to which positive-polarity data pulses 304 are to be applied are determined based on an image signal obtained from outside.

While the negative-polarity scan pulses 303 are sequentially applied to the scan electrodes 101, positive-polarity sustain write pulses 306 are applied to the sustain electrodes 102 so that, each time the write discharge is caused, positive electronic charge is accumulated in the dielectric on the scan electrodes 101, and negative electronic charge is accumulated in the dielectric on the sustain electrodes 102 (Writing Process).

A period in a subfield in which the writing process is performed is called a writing period.

A high-voltage sustain pulse 305 is applied alternately to the scan electrodes 101 and the sustain electrodes 102.

Sustain discharge is generated only in the cells in which write discharge has been caused in the writing period, that is, in the cells for which negative electronic charge is accumulated in the dielectric on the sustain electrodes 102 (Sustain Process).

A period in a subfield in which the sustain process is performed is called a sustain period.

The sustain discharge allows light, which in the end provides an image display, to be emitted.

The sustain period ends after applying sustain pulses to the scan electrodes 101. As a result, immediately after the sustain period, positive electronic charge has been accumulated in the sustain electrodes 102.

The above-described voltage application procedure is performed in each subfield making up one field.

Such a plasma display panel driving method containing in each subfield the initialization process, writing process, sustain process, and erasure process is called an ADS (Address Display period Separated subfield) driving method.

The ADS driving method is disclosed in, for example, Japanese Laid-Open Patent Application No. 6-186927 “Display Panel Driving Method and Apparatus” and Japanese Laid-Open Patent Application No. 5-307935 “Plasma Display Apparatus”.

Meanwhile, a plasma display panel consumes a larger amount of power than a CRT of the same screen size. As a result, there has always been a demand for reducing the power requirements of plasma display panels.

A plasma display panel driving method responding to the above demand is disclosed in Japanese Laid-Open Patent Application No. 2000-227778 “Plasma Display Panel Driving Method”.

In this driving method, the writing is performed in only one of a set of sequential subfields, and only the last one of the set of sequential subfields has the erasure period.

In this driving method, the cell is not lighted (the state of OFF) in the sustain period of each subfield up to immediately before the subfield in which the writing is performed, and the cell is lighted (the state of ON) in the sustain period of each subfield thereafter including the writing-performed subfield.

That is to say, in this method, the state of ON or OFF is switched only once when the writing is performed in one of a set of sequential subfields.

Such a driving method is called STCE (Single Triggered Continuous Emission) driving method in which the writing is not performed for each subfield, but is performed only once and the writing is used as a trigger, where the cell is continuously OFF before the writing and is continuously ON after the writing.

The above-shown examples of the ADS driving method and the STCE driving method, a positive logic writing in which the initial state is OFF is adopted. However, there also exists a negative logic writing in which the initial state is ON.

In the ADS driving method adopting the negative logic writing, in each subfield, the cell is turned ON in the initialization period and only when the writing is performed in the writing period, the cell is turned OFF in the sustain period.

In the STCE driving method adopting the negative logic writing, the cell is continuously ON from the initial state onwards and is turned ON in the sustain period in each subfield in a set of sequential subfields until a writing is performed in one of the set of subfields, and the cell is continuously OFF for the rest of subfields after the writing.

In the following description, except in cases where a particular notice is provided, it is supposed that the STCE driving method is based on the positive logic writing.

FIG. 3 shows waveforms of voltages applied by the STCE driving method to the scan electrodes 101, sustain electrodes 102, and data electrodes 103.

In FIG. 3, the time flows from the left-hand side to the right-hand side. This also applies to the other figures showing a field.

The STCE driving method differs from the ADS driving method in that only the first subfield in a set of sequential subfields has the initialization period, and an initialization pulse 332 is applied in the initialization period, and that the erasure process is performed only in the last subfield in the set of sequential subfields, and a positive-polarity, high-voltage erase pulse is applied to the sustain electrodes 102 in the erasure process.

The STCE driving method has an advantage compared with the ADS driving method that it consumes a less amount of power for the writing or the writing discharge since writing is performed in less times. On the other hand, the STCE driving method has a disadvantage compared with the ADS driving method that since a smaller number of combinations of subfields is available for turning on a cell, a limited number of gray scale levels is available.

To solve the above problem, an improvement has been provided as shown in FIG. 4. In the method shown in FIG. 4, one field is divided into two subfield groups. In one subfield group, voltages are applied by the STCE driving method, and in the other subfield group, voltages are applied by the ADS driving method.

In the present document, the subfield group in which voltages are applied by the STCE driving method is referred to as a subfield group S, and the subfield group in which voltages are applied by the ADS driving method is referred to as a subfield group A.

Note also that in the present document, when one field is divided into n subfields in the time domain, the subfields may be denoted by SF1, SF2, SF3, . . . SFn. This also applies to the drawings. In the example shown in FIG. 4, n is 10.

In some attempts to improve the technique in recent years, a plurality of subfield groups S are included in one field, or the STCE driving method and the ADS driving method are combined.

By combining the STCE driving method and the ADS driving method, the power consumption is reduced and the number of available gray scale levels is increased. However, this method has the following problem.

When watching an image with an image update rate lower than 60 frames per second, humans feel the whole screen flicker (hereinafter, such phenomenon is referred to as flickering). This is because with such a low image update rate, humans do not benefit from the effects of after-image. The PAL (Phase Alternation by Line) video standard, which is popular in Europe, defines the image update rate as 50 frames per second, which can cause the flickering.

In the ADS driving method, the light emission tends to occur in a distributed manner over time. In contrast, in the STCE driving method, subfields in which the light is ON tend to concentrate on a certain period of each field. This causes the peak of luminance to exist in such a period in each field. The cycle of the peak often matches 50 frames per second. As a result, the flickering problem is apt to occur in the STCE driving method.

### DISCLOSURE OF THE INVENTION

It is the object of the present invention to provide a plasma display panel driving method or apparatus, or a plasma display apparatus that ensures a low power consumption and a satisfactory number of gray scale levels and provides improved image quality even when displaying an image with a low image update rate (frames/second).

The above object is fulfilled by a plasma display panel driving method for displaying a gray-scale image on a screen by selecting, according to a luminance level of an input image signal, subfields from a set of subfields making up one field in the time domain, and applying a voltage to a cell in a writing period and sustaining a state of the cell in a sustain period in the selected subfields, wherein one field is divided into F first subfield groups and M second subfield groups, where F is a natural number no lower than 2, and M is a natural number no lower than 1, each subfield group being composed of consecutive subfields, a time interval between respective starting points or respective ending points of two consecutive first subfield groups is approximately a time period of one field×1/F, in each first subfield group, a light emitting state of ON or OFF is continued until a writing is performed, after which a reversed light emitting state is kept in each of succeeding sustain periods, and in each subfield making up the second subfield groups, a light emitting state of ON or OFF is set in a sustain period only when a writing is performed.

With the above-described construction, the F first subfield groups, in which light may be emitted continuously, are evenly distributed in one field. A period in which light is emitted continuously tends to have a peak of luminance. Accordingly, the above-described construction causes F high-luminance light emitting periods to happen evenly in one field. This increases the apparent image update rate by F times, resulting in the suppression of the flickering on the screen. Here, the construction of one field having a plurality of first subfield groups and a plurality of second subfield groups provides two effects: (i) the power consumption in total is reduced with the first subfield groups, in which only one writing is performed to switch the light emitting state of ON/OFF through the whole period of the first subfield groups, consuming less amount of power than the second subfield groups; and (ii) the number of gray scale levels is increased in total by the presence of the second subfield groups. It should be noted here that the first subfield groups are also referred to as subfield groups S to which the STCE driving method is applied, and that the second subfield groups are also referred to as subfield groups A to which the ADS driving method is applied. The above-described construction, in which one field is composed of two or more subfield groups S and one or more subfield groups A, ensures a low power consumption and a satisfactory number of gray scale levels, while providing improved image quality.

In the above plasma display panel driving method, the time interval between respective starting points or respective ending points of two consecutive first subfield groups may be in a range from (the time period of one field)×1/F×0.9 to (the time period of one field)×1/F×1.1.

The above-described construction further ensures that the first subfield groups are evenly distributed in one field. This is because peaks of luminance are evenly distributed with high accuracy in each field in the time domain, which causes F peaks of luminance to be recognized, suppressing the flickering with more accuracy.

In the above plasma display panel driving method, in each first subfield group, a light emitting state of OFF maybe continued until a writing is performed, after which a light emitting state of ON is continued in each of succeeding sustain periods, in each subfield making up the second subfield groups, a light emitting state of ON is set in a sustain period only when a writing is performed, and at least one first subfield group is followed by a second subfield group.

With the above-described construction, the interval between the light emitting in a first subfield group and that in the succeeding second subfield group is reduced. This tends to combine the two peaks of luminance in to one. This suppresses the occurrence of the moving image false edge due to the presence of no light emitting period between light emitting in such subfield groups, in a driving based on the positive logic writing.

In the above plasma display panel driving method, the values F and M may be equal, and the subfield groups in the field are arranged repeatedly in an order in which a first subfield group comes first and then a second subfield group comes.

With the above-described construction, occurrences of light emitting in each pair of a first subfield group and an adjacent second subfield group are combined to one occurrence of light emitting in one period, increasing the luminance. This tends to enhance the F peaks of luminance, which facilitates the increase in the apparent image update rate by F times, resulting in the suppression of the flickering in a driving based on the positive logic writing.

In the above plasma display panel driving method, in each first subfield group, a light emitting state of ON may be continued until a writing is performed, after which a light emitting state of OFF is continued in each of succeeding sustain periods, in each subfield making up the second subfield groups, a light emitting state of OFF is set in a sustain period only when a writing is performed, and a second subfield group is followed by at least one first subfield group.

With the above-described construction, the interval between the light emitting in a first subfield group and that in the succeeding second subfield group is reduced. This tends to combine the two peaks of luminance in to one. This suppresses the occurrence of the moving image false edge due to the presence of no light emitting period between light emitting in such subfield groups, in a driving based on the negative logic writing.

In the above plasma display panel driving method, the values F and M may be equal, and the subfield groups in the field are arranged repeatedly in an order in which a second subfield group comes first and then a first subfield group comes.

With the above-described construction, occurrences of light emitting in each pair of a first subfield group and an adjacent second subfield group are combined to one occurrence of light emitting in one period, increasing the luminance. This tends to enhance the F peaks of luminance, which facilitates the increase in the apparent image update rate by F times, resulting in the suppression of the flickering in a driving based on the negative logic writing.

In the above plasma display panel driving method, a difference in the number of subfields between any pair of first subfield groups may be no higher than “1”.

The above-described construction prevents the luminance from being lopsided toward one of the first subfield groups. As the luminance of one first subfield group increases, it becomes difficult for humans to recognize the peaks of the other first subfield groups. To avoid this phenomenon and the flickering, a balance between peaks of luminance in the first subfield groups should be ensured as the gray scale increases.

In the above plasma display panel driving method, when there are a plurality of combinations of subfields for a certain gray scale level in terms of the first subfield groups in a condition that a writing state of the second subfield groups should not be changed, a combination of subfields in which totals of luminance weights of ON subfields, in which light is emitted, in respective first subfield groups are most evenly arranged may be selected from the plurality of combinations.

The above-described construction prevents the luminance from being lopsided toward one of the first subfield groups. That is to say, the above-described construction prevents the occurrence of flickering with more accuracy by allowing the luminance weights to increase alternately between a plurality of first subfield groups as the gray scale increases. In the above plasma display panel driving method, luminance weights assigned to subfields in the first subfield groups may be equal, and S subfields are contained in the second subfield groups in one field in total, where S is a natural number no lower than 1, and different luminance weights, each of which is 2 raised to the N^{th} power, where N is a natural number in a range from 0 to S−1 inclusive, are assigned to the S subfields.

With the above-described construction, a minuter gray scale expression is achieved.

In the above plasma display panel driving method, the values F and M may be both 2, the subfield groups in the field are arranged repeatedly in an order in which a first subfield group comes first and then a second subfield group comes, and luminance weights 64, 48, 48, 32, and 16 are assigned in the stated order to five subfields of the first of the two first subfield groups, luminance weights 32, 16, and 8 are assigned in the stated order to three subfields of the first of the two second subfield groups, luminance weights 48, 32, 32, and 32 are assigned in the stated order to four subfields of the second of the two first subfield groups, and luminance weights 4, 2, and 1 are assigned in the stated order to three subfields of the second of the two second subfield groups.

With the above-described construction, one field has two periods in which light is continuously emitted. This doubles the apparent image update rate, suppressing the occurrence of flickering. Also, in the first subfield groups, only one writing is performed to switch the light emitting state of ON/OFF through the whole period of the first subfield groups, consuming less amount of power than the second subfield groups. Furthermore, the number of gray scale levels is increased in total, and 0-415 gray scale levels are available by the presence of the second subfield groups in one field.

The above object is also fulfilled by a plasma display panel driving method for displaying a gray-scale image on a screen by selecting, according to a luminance level of an input image signal, subfields from a set of subfields making up one field in the time domain, and applying a voltage to a cell in a writing period and sustaining a state of the cell in a sustain period in the selected subfields, wherein one field is divided into F first subfield groups and M second subfield groups, where F is a natural number no lower than 2, and M is a natural number no lower than 1, each subfield group being composed of consecutive subfields, in each first subfield group, a light emitting state of OFF is continued until a writing is performed, after which a light emitting state of ON is kept in each of succeeding sustain periods, in each subfield making up the second subfield groups, a light emitting state of ON is set in a sustain period only when a writing is performed, S subfields are contained in the second subfield groups in one field in total, where S is a natural number no lower than 1, and different luminance weights, each of which is 2 raised to the N^{th} power, where N is a natural number in a range from 0 to S−1 inclusive, are assigned to the S subfields, and in each first subfield group, a luminance weight assigned to a subfield is equal to or smaller than a luminance weight assigned to a subfield immediately before.

With the above-described construction, the F first subfield groups, in which light may be emitted continuously, are evenly distributed in one field. A period in which light is emitted continuously tends to have a peak of luminance. Accordingly, the above-described construction causes F high-luminance light emitting periods to happen evenly in one field. This increases the apparent image update rate by F times, resulting in the suppression of the flickering on the screen. At the same time, in the first subfield groups, smaller luminance weights are assigned to the latter subfields. This achieves a minuter gray scale expression since light is emitted more frequently in the latter subfields. Furthermore, in the first subfield groups, only one writing is performed to switch the light emitting state of ON/OFF through the whole period of the first subfield groups, consuming less amount of power than the second subfield groups. The above-described construction ensures a low power consumption and a satisfactory number of gray scale levels, while providing improved image quality.

In the above plasma display panel driving method, a minimum luminance weight among luminance weights assigned to subfields of at least one first subfield group may be no higher than a total of luminance weights assigned to subfields of all the second subfield groups.

With the above-described construction, when gray scale is increased gradually starting with the lowest gray scale level, in a stage which comes after a stage where light is emitted in all the subfields in the second subfield groups, light emitting is continued in part of the light-emitting subfields of the preceding stage. This reduces the amount of movement of the luminance center between these stages, and suppresses the occurrence of the moving image false edge.

In the above plasma display panel driving method, when gray scale is increased gradually starting with the lowest gray scale level, a luminance weight assigned to a subfield in which light is emitted first in the first subfield groups is no higher than a total of luminance weights assigned to light-emitted subfields of a second subfield group before the first light-emitted subfield in the first subfield groups.

With the above-described construction, when gray scale is increased gradually starting with the lowest gray scale level, in a stage which comes after a stage where light is emitted in all the subfields in the second subfield groups, light emitting is continued in part of the light-emitting subfields of the preceding stage. This reduces the amount of movement of the luminance center between these stages, and suppresses the occurrence of the moving image false edge.

In the above plasma display panel driving method, through the second subfield groups in one field, a luminance weight assigned to a subfield is smaller than a luminance weight assigned to a subfield immediately before.

With the above-described construction, when gray scale is increased gradually starting with the lowest gray scale level in the second subfield groups, the luminance center moves less, suppressing the occurrence of the moving image false edge.

In the above plasma display panel driving method, a first subfield group containing a first subfield may be adjacent to a second subfield group containing a second subfield, the first subfield being a subfield in which light is emitted first in the first subfield groups when gray scale is increased gradually starting with the lowest gray scale level, and the second subfield being a subfield to which, among light-emitted subfields of second subfield groups before the first subfield, a largest luminance weight is assigned.

With the above-described construction, when gray scale is increased gradually starting with the lowest gray scale level, the luminance center moves less when light is emitted first in the first subfield groups, which suppresses the occurrence of the moving image false edge.

In the above plasma display panel driving method, the first subfield may be adjacent to the second subfield.

With the above-described construction, when gray scale is increased gradually starting with the lowest gray scale level, the luminance center moves less when light is emitted first in the first subfield groups, which suppresses the occurrence of the moving image false edge.

The above object is also fulfilled by a plasma display panel driving method for displaying a gray-scale image on a screen by selecting, according to a luminance level of an input image signal, subfields from a set of subfields making up one field in the time domain, and applying a voltage to a cell in a writing period and sustaining a state of the cell in a sustain period in the selected subfields, wherein one field is divided into F first subfield groups and M second subfield groups, where F is a natural number no lower than 2, and M is a natural number no lower than 1, each subfield group being composed of consecutive subfields, in each first subfield group, a light emitting state of ON is continued until a writing is performed, after which a light emitting state of OFF is kept in each of succeeding sustain periods, in each subfield making up the second subfield groups, a light emitting state of OFF is set in a sustain period only when a writing is performed, S subfields are contained in the second subfield groups in one field in total, where S is a natural number no lower than 1, and different luminance weights, each of which is 2 raised to the N^{th} power, where N is a natural number in a range from 0 to S−1 inclusive, are assigned to the S subfields, and in each first subfield group, a luminance weight assigned to a subfield is equal to or greater than a luminance weight assigned to a subfield immediately before.

With the above-described construction, the F first subfield groups, in which light may be emitted continuously, are evenly distributed in one field. A period in which light is emitted continuously tends to have a peak of luminance. Accordingly, the above-described construction causes F high-luminance light emitting periods to happen evenly in one field. This increases the apparent image update rate by F times, resulting in the suppression of the flickering on the screen. At the same time, in the first subfield groups, smaller luminance weights are assigned to the latter subfields. This achieves a minuter gray scale expression since light is emitted more frequently in the latter subfields. Furthermore, in the first subfield groups, only one writing is performed to switch the light emitting state of ON/OFF through the whole period of the first subfield groups, consuming less amount of power than the second subfield groups. The above-described construction ensures a low power consumption and a satisfactory number of gray scale levels, while providing improved image quality.

In the above plasma display panel driving method, a minimum luminance weight among luminance weights assigned to subfields of at least one first subfield group may be no higher than a total of luminance weights assigned to subfields of all the second subfield groups.

With the above-described construction, when gray scale is increased gradually starting with the lowest gray scale level, in a stage which comes after a stage where light is emitted in all the subfields in the second subfield groups, light emitting is continued in part of the light-emitting subfields of the preceding stage. This reduces the amount of movement of the luminance center between these stages, and suppresses the occurrence of the moving image false edge.

In the above plasma display panel driving method, when gray scale is increased gradually starting with the lowest gray scale level, a luminance weight assigned to a subfield in which light is emitted first in the first subfield groups may be no higher than a total of luminance weights assigned to light-emitted subfields of a second subfield group before the first light-emitted subfield in the first subfield groups.

With the above-described construction, when gray scale is increased gradually starting with the lowest gray scale level, in a stage which comes after a stage where light is emitted in all the subfields in the second subfield groups, light emitting is continued in part of the light-emitting subfields of the preceding stage. This reduces the amount of movement of the luminance center between these stages, and suppresses the occurrence of the moving image false edge.

In the plasma display panel driving method, through the second subfield groups in one field, a luminance weight assigned to a subfield may be greater than a luminance weight assigned to a subfield immediately before.

With the above-described construction, when gray scale is increased gradually starting with the lowest gray scale level in the second subfield groups, the luminance center moves less, suppressing the occurrence of the moving image false edge.

In the above plasma display panel driving method, a first subfield group containing a first subfield may be adjacent to a second subfield group containing a second subfield, the first subfield being a subfield in which light is emitted first in the first subfield groups when gray scale is increased gradually starting with the lowest gray scale level, and the second subfield being a subfield to which, among light-emitted subfields of second subfield groups before the first subfield, a largest luminance weight is assigned.

With the above-described construction, when gray scale is increased gradually starting with the lowest gray scale level, the luminance center moves less when light is emitted first in the first subfield groups, which suppresses the occurrence of the moving image false edge.

In the above plasma display panel driving method, the first subfield may be adjacent to the second subfield.

With the above-described construction, when gray scale is increased gradually starting with the lowest gray scale level, the luminance center moves less when light is emitted first in the first subfield groups, which suppresses the occurrence of the moving image false edge.

In the above plasma display panel driving method, the values F and M may be both 2, the subfield groups in the field are arranged repeatedly in an order in which a second subfield group comes first and then a first subfield group comes, and luminance weights 1, 2, and 4 are assigned in the stated order to three subfields of the first of the two second subfield groups, luminance weights 32, 32, 32, and 48 are assigned in the stated order to four subfields of the first of the two first subfield groups, luminance weights 8, 16, and 32 are assigned in the stated order to three subfields of the second of the two second subfield groups, and luminance weights 16, 32, 48, 48, and 64 are assigned in the stated order to five subfields of the second of the two first subfield group.

With the above-described construction, one field has two periods in which light is continuously emitted. This doubles the apparent image update rate, suppressing the occurrence of flickering. Also, in the first subfield groups, only one writing is performed to switch the light emitting state of ON/OFF through the whole period of the first subfield groups, consuming less amount of power than the second subfield groups. Furthermore, the number of gray scale levels is increased in total, and 0-415 gray scale levels are available by the presence of the second subfield groups in one field.

The above object is also fultilled by a plasma display panel driving apparatus that drives a plasma display panel using one of the above plasma display panel driving methods.

With the above-described construction, the F first subfield groups, in which light may be emitted continuously, are evenly distributed in one field. A period in which light is emitted continuously tends to have a peak of luminance. Accordingly, the above-described construction causes F high-luminance light emitting periods to happen evenly in one field. This increases the apparent image update rate by F times, resulting in the suppression of the flickering on the screen. Furthermore, in the first subfield groups, only one writing is performed to switch the light emitting state of ON/OFF through the whole period of the first subfield groups, consuming less amount of power than the second subfield groups. Furthermore, the number of gray scale levels is increased in total by the presence of the second subfield groups in one field. The above-described construction, in which one field is composed of two or more subfield groups S and one or more subfield groups A, ensures a low power consumption and a satisfactory number of gray scale levels, while providing improved image quality.

The above object is also fultilled by a plasma display apparatus that comprises: a plasma display panel; and a plasma display panel driving apparatus that drives the plasma display panel using one of the above plasma display panel driving methods.

With the above-described construction, the F first subfield groups, in which light may be emitted continuously, are evenly distributed in one field. A period in which light is emitted continuously tends to have a peak of luminance. Accordingly, the above-described construction causes F high-luminance light emitting periods to happen evenly in one field. This increases the apparent image update rate by F times, resulting in the suppression of the flickering on the screen. Furthermore, in the first subfield groups, only one writing is performed to switch the light emitting state of ON/OFF through the whole period of the first subfield groups, consuming less amount of power than the second subfield groups. Furthermore, the number of gray scale levels is increased in total by the presence of the second subfield groups in one field. The above-described construction, in which one field is composed of two or more subfield groups S and one or more subfield groups A, ensures a low power consumption and a satisfactory number of gray scale levels, while providing improved image quality.

### BRIEF DESCRIPTION OF THE DRAWINGS

FIG. 1 shows the construction of the electrodes in a typical plasma display panel, and three driving circuits used for the gray-scale image display.

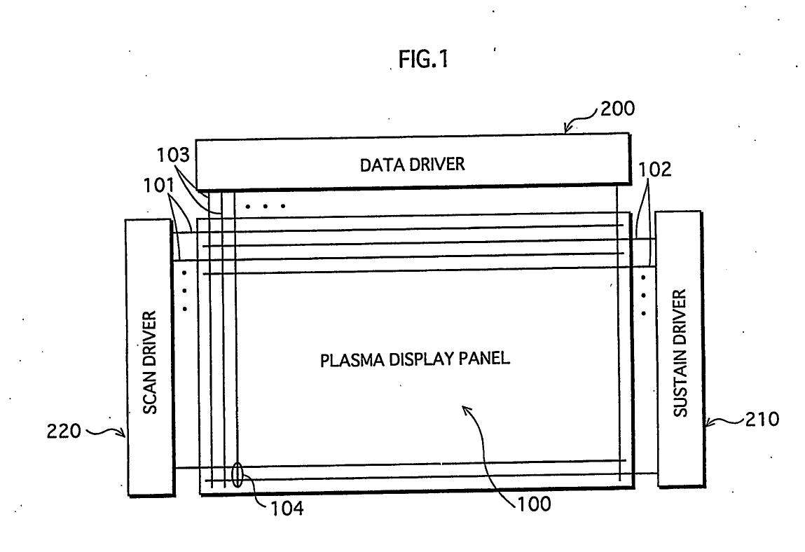

FIG. 2 shows waveforms of voltages applied by a typical plasma display panel driving method to the scan, sustain, and data electrodes.

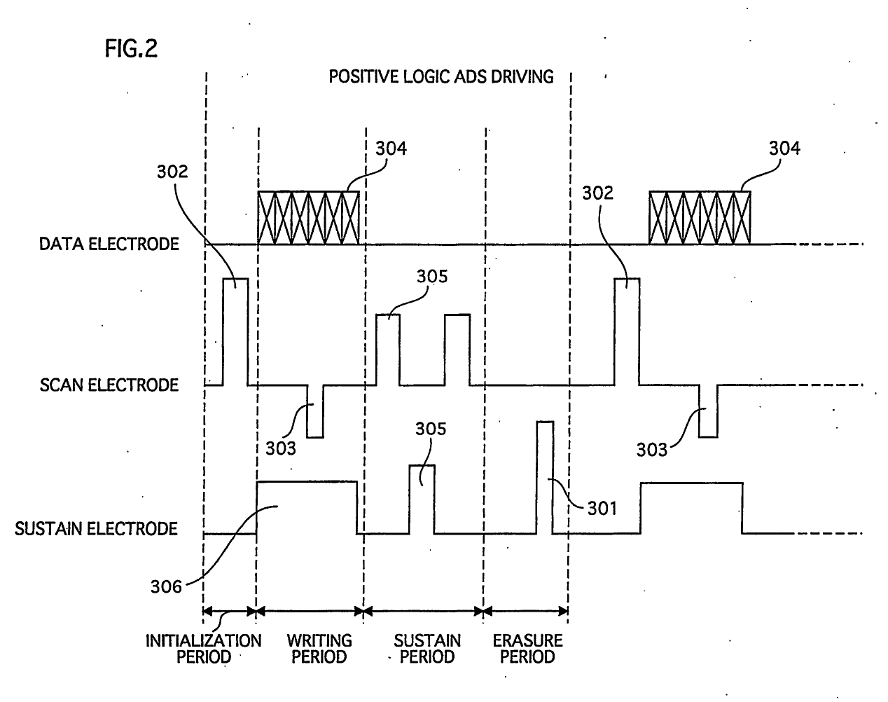

FIG. 3 shows waveforms of voltages applied by the STCE driving method to the scan, sustain, and data electrodes.

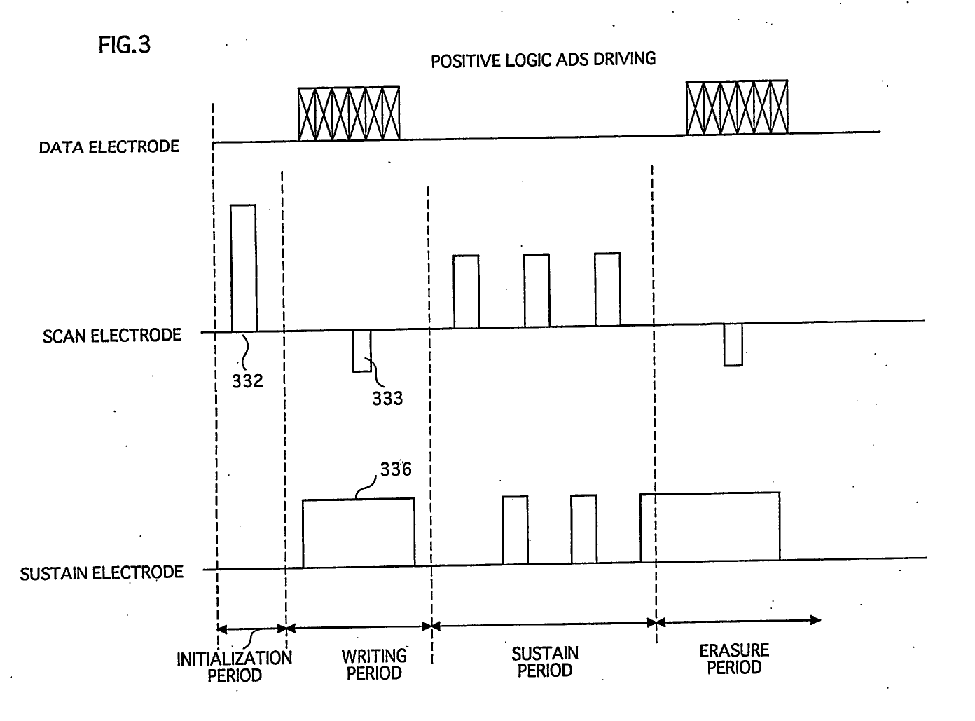

FIG. 4 the construction of one field when both the STCE driving method and the ADS driving method are used.

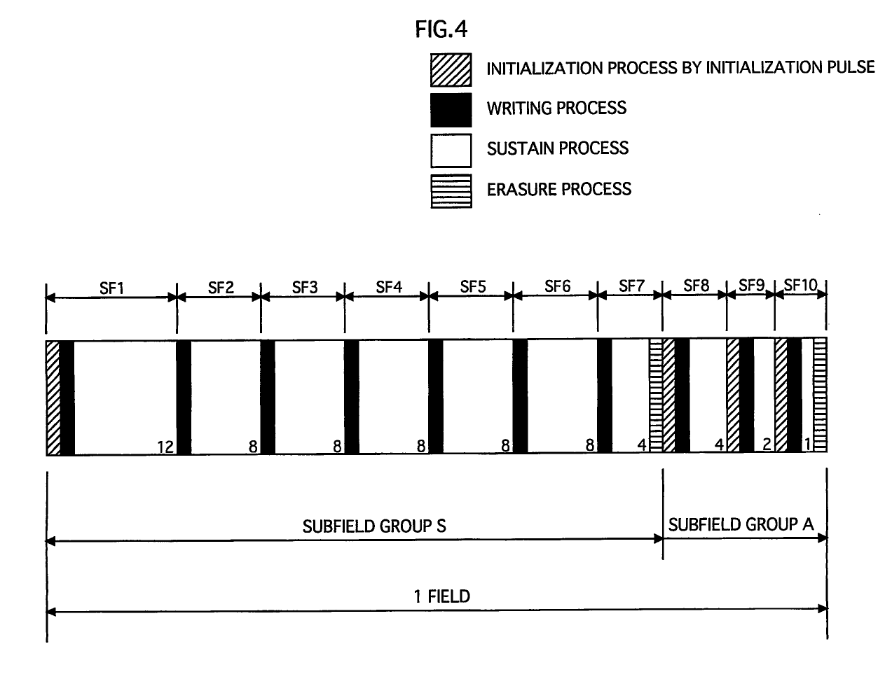

FIG. 5 shows the construction of a plasma display apparatus in Embodiment 1.

FIG. 6 shows the operation performed in one field by the driving method in the present embodiment.

FIG. 7 shows an example of the conversion table stored in the subfield converting unit for the STCE driving and ADS driving.

FIG. 8 shows an arrangement of subfields in a field in which the size and the order of the luminance weights assigned to subfield groups A are not taken into consideration.

FIG. 9 shows a table defining writing positions and order in the field shown in FIG. 8 for gray-scale image displays.

FIG. 10 shows an arrangement of 15 subfields making up a field to which the plasma display panel driving method of Embodiment 1 is applied.

FIG. 11 shows a table defining writing positions and order in the field shown in FIG. 10 for gray-scale image displays.

FIG. 12 shows the operation performed in one field by the driving method in Embodiment 2.

FIG. 13 shows an example of the conversion table stored in the subfield converting unit for the STCE driving and ADS driving based on the negative logic writing.

FIG. 14 shows waveforms of voltages applied by the STCE driving method based on the negative logic writing, to the scan, sustain, and data electrodes.

FIG. 15 shows an arrangement of 15 subfields in one field to which the plasma display panel driving method of Embodiment 2 is applied.

FIG. 16 shows a table defining writing positions and order in the field shown in FIG. 10 for gray-scale image displays.

### BEST MODE FOR CARRYING OUT THE INVENTION

The following describes embodiments of the present invention with reference to the attached drawings. It should be noted here that these embodiments are mere examples of the present invention, and that the present invention is not limited to these embodiments.

Embodiment 1

Construction

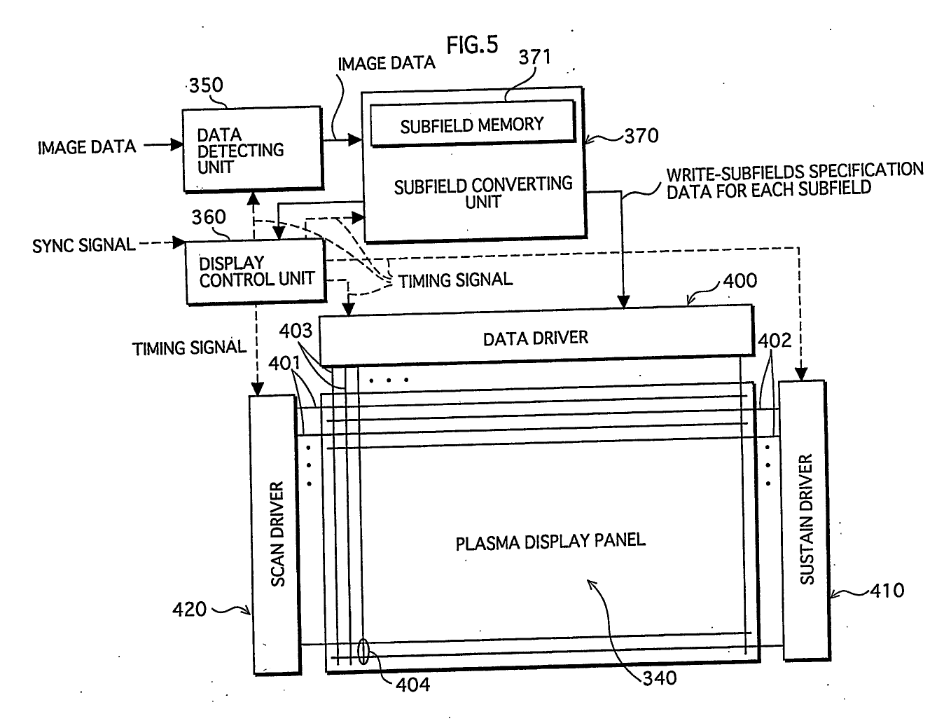

FIG. 5 shows the construction of a plasma display apparatus in Embodiment 1.

The plasma display apparatus includes a plasma display panel 340, a data detecting unit 350, a display control unit 360, a subfield converting unit 370, a data driver 400, a scan driver 420, and a sustain driver 410.

The plasma display panel 340 includes a pair of a front substrate and a back substrate. A plurality of scan electrodes 401 and a plurality of sustain electrodes 402, both of which extend horizontally on the screen, are arranged on a surface of the front substrate, and a plurality of data electrodes 403, which extend vertically on the screen, are arranged on a surface of the back substrate.

As shown in FIG. 5, the data electrodes 403 are arranged perpendicular to the scan electrodes 401 and the sustain electrodes 402 so as to form a matrix.

A discharge cell 404 is formed at an area near two intersections of a data electrode 403 and a pair of a scan electrode 401 and a sustain electrode 402.

Each of discharge cells 404 is filled with a discharge gas.

One pixel on the screen is made of three discharge cells (red, green, and blue) that are adjacent horizontally on the screen.

The data detecting unit 350 receives image data which indicates the gray scale level of each cell on the plasma display panel 340. For example, when a cell can represent any of 256 levels of gray scale, a gray scale level of a cell is indicated by 8-bit image data.

The data detecting unit 350 sequentially transfers the image data (the gray scale levels of each cell) to the subfield converting unit 370. In this operation, the image data (the gray scale levels of each cell) is transferred, for example, in the order in which the cells are arranged on the plasma display panel 340.

The subfield converting unit 370 contains a conversion table in which each gray scale level corresponds to a different combination of subfields in a field. For example, one field is divided into 10 subfields in the time domain. Receiving image data (a gray scale level) of a cell from the data detecting unit 350, the subfield converting unit 370 generates a piece of write-subfields specification data (that is, the information indicating the subfields in a field in which data is written) for the cell corresponding to the received image data based on the conversion table. Then, based on all pieces of write-subfields specification data on the screen, the subfield converting unit 370 generates write-cells specification data indicating, for each subfield in a field, discharge cells on the screen where data is written, and sends the generated write-cells specification data to the data driver 400.

The display control unit 360 receives an image signal and a sync signal (for example, a horizontal sync signal (Hsyc) or a vertical sync signal (Vsyc)) sent in synchronization with each other.

The display control unit 360 provides, based on the sync signal: the data detecting unit 350 with a timing signal indicating timing of a transfer of image data; the subfield converting unit 370 with a timing signal indicating timing of reading or writing data from/to the subfield memory 371; and the data driver 400, the scan driver 420, and the sustain driver 410 with timing signals indicating timing of applying pulses, respectively.

The display control unit 360 has information that defines how the “non-operation period”, which will be described later, should be assigned to between each pair of adjacent subfields, and generates each of the above-described timing signals based on this information.

The data driver 400 is connected to a plurality of data electrodes 403, and applies write pulses selectively to the plurality of data electrodes 403 in the write period for each subfield so that each discharge cell 404 can perform a writing discharge in a stable manner.

The scan driver 420 is connected to a plurality of scan electrodes 401, and applies initialization pulses, sustain pulses, scan pulses, or erase pulses to the plurality of scan electrodes 401 in the initialization period, write period, or erase period for each subfield so that each discharge cell 404 can perform an initialization discharge, a write discharge, a sustain discharge, or an erase discharge in a stable manner.

The sustain driver 410 is connected to a plurality of sustain ectrodes 402, and applies sustain pulses or pulses for writing or erasure to the plurality of sustain electrodes 402 in the initialization period, write period, or erase period for each subfield so that each discharge cell 404 can perform an initialization discharge, a write discharge, a sustain discharge, or an erase discharge in a stable manner.

Driving Method

The driving method in the present embodiment will be explained here.

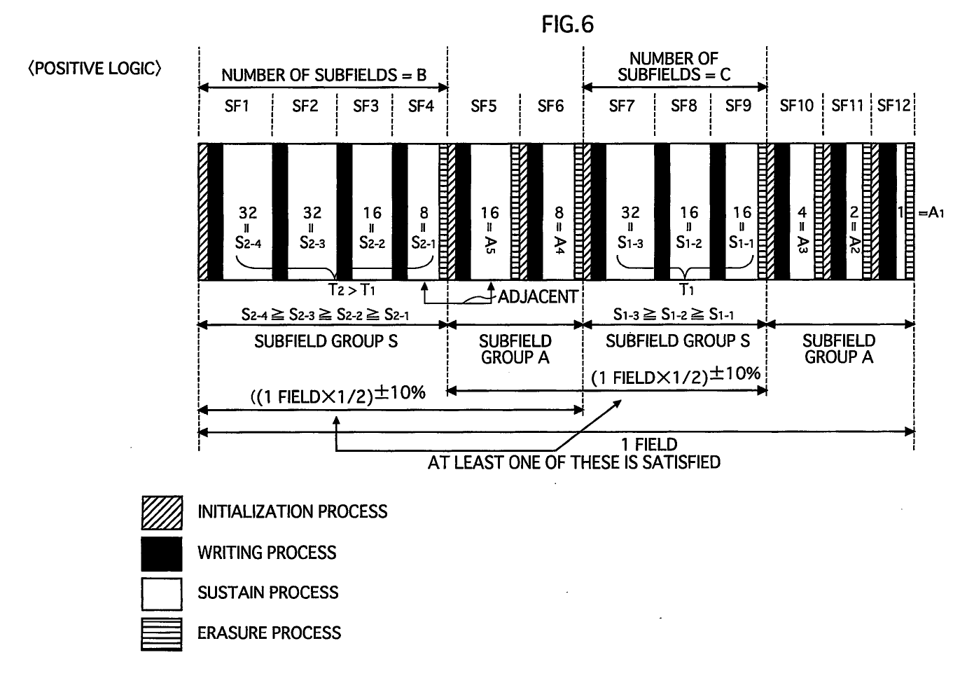

FIG. 6 shows the operation performed in one field by the driving method in the present embodiment.

As shown in FIG. 6, in the present embodiment, one field is divided into 12 subfields (SF1-SF12) in the time domain.

The STCE driving method is applied to SF1-SF4 and SF7-SF9 which are referred to as subfield groups S. That is to say, in each subfield group S, either only one data writing is performed or no data writing is performed. For example, in the case shown in FIG. 6, if a data writing is performed in SFm in the first subfield group S, light is not emitted in SF1 through SFm-1 which is immediately before SFm, and light is emitted in SFm through the last subfield SF4 in the first subfield group S.

If no data writing is performed in a subfield group S, light is not emitted in any subfield in the subfield group S.

The latter subfield group S in the set of 12 subfields is similarly controlled.

The ADS driving method is applied to SF5-SF6 and SF10-SF12 which are referred to as subfield groups A. That is to say, in each subfield in the subfield groups A, the initialization, writing, sustain, and erasure processes are performed.

Luminance weights of 32, 32, 16, 8, 16, 8, 32, 16, 16, 4, 2, 1 are respectively assigned to SF1 to SF12, providing 183 gray scale levels.

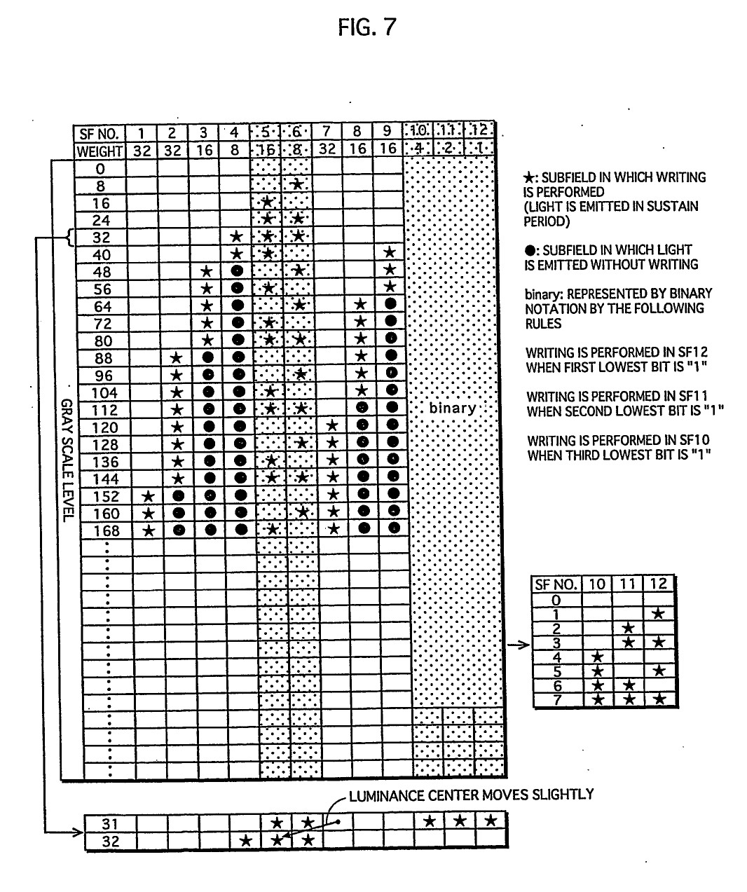

FIG. 7 shows an example of the conversion table stored in the subfield converting unit 370 for the STCE driving and ADS driving.

In FIG. 7, the star mark indicates that the writing is performed and the light is emitted in the subfield, and the black circle indicates that the light is emitted but no writing is performed in the subfield, which is unique to the STCE driving method.

The driving method of the present embodiment is characterized by the respective numbers of subfield groups S and A in a field and the arrangement thereof, and also by the number of subfields for each subfield group, and a relative luminance ratio, that is, how the luminance weights are assigned to the subfields.

The following describes such settings in detail.

Settings

(1) All subfields are driven based on the positive logic writing.

(2) One field contains two subfield groups S and two subfield groups A.

(3) A subfield group S is always followed by a subfield group A.

(4) When there are a plurality of combinations of subfields in terms of the two subfield groups S for a certain gray scale level in the condition that the writing state of the two subfield groups A should not be changed, a combination of subfields is selected among them so that a difference between (i) the total of luminance weights of the ON subfields (in which light is emitted) in one of the two subfield groups S and (ii) the total of luminance weights of the ON subfields in the other is the smallest.

For example, in the case shown in FIG. 7, to display a gray scale level “48”, light may be emitted in SF8 instead of SF3 since they are assigned the same luminance weight. However, according to the setting (4), the difference between the total luminance weights of ON subfields in two subfield groups S (in this case, a subfield group S containing SF1-SF4 and a subfield group S containing SF7-SF9) should be the smallest. As a result, the combination, shown in FIG. 7, of subfields for the gray scale level “48” is selected.

(5) The time interval between the two subfield groups S (from the start to the start, or from the end to the end) is in a range from (a) “(the time period of one field)×½×0.9” to (b) “(the time period of one field)×½×1.1”.

Although not illustrated, there exists a “non-operation” period between each pair of adjacent subfields. In general, each pair of adjacent subfields has an evenly assigned non-operation period in between. However, in the present embodiment, the non-operation period is determined for each pair of adjacent subfields to achieve the above setting of time interval between two consecutive subfield groups S.

In setting the time interval between two consecutive subfield groups S, the starting points of the first subfiels of respective subfield groups S or the ending points of the last subfiels of respective subfield groups S are obtained as the standard.

A total of the non-operation periods in one field is obtained by subtracting the time required for executing each process in each subfield from the total time period of one field. The present invention is based on a presumption that the image update rate is as low as 50 frames per second as in the PAL video standard. Accordingly, compared with the case in which the image update rate is 60 frames per second as in the NTSC (National Television Standard Committee) video standard, a total of non-operation periods is long. As a result, there is enough total length of the non-operation periods to ensure that the time interval between the two subfield groups S is in the above-stated range.

(6) The difference in the number of subfields between the two subfield groups S is no more than “1”.

(7) In each subfield group S, a luminance weight assigned to a subfield is equal to or smaller than that assigned to a subfield immediately before.

(8) The luminance weight assigned to the last subfield in all the subfield groups A is “1”, and a luminance weight assigned to the k^{th} subfield from the last subfield is “2 raised to the (k−1)^{th} power”.

Here, a subfield having a value L being the maximum value of k is referred to as “maximum subfield A”.

(9) The minimum luminance weight among the luminance weights assigned to the subfields of all the subfield groups S is no higher than “2^{L}−1”, which is the total of the luminance weights assigned to subfields of all the subfield groups A.

Here, a subfield in the subfield groups S to which the minimum luminance weight is assigned is referred to as “minimum subfield S”.

When there are a plurality of subfields to which the minimum luminance weight is assigned in the subfield groups S, the minimum subfield S is a subfield in which light is emitted first in the subfield groups S when the displayed gray scale level is increased starting with the lowest gray scale level.

(10) The minimum subfield S is adjacent to the maximum subfield A in each set of subfields constituting one field.

More particularly, in the example shown in FIG. 6, SF4 (minimum subfield S) to which luminance weight S₂₋₁ is assigned is adjacent to SF5 (maximum subfield A) to which luminance weight A₅ is assigned.

Now, the present driving method will be explained in detail by referring to the reason for the above settings (1) to (10).

Reason for Settings

(1) A driving based on the positive logic writing is a prerequisite for the present embodiment. A driving based on the negative logic writing will be described later.

(2) The reason why one field should contain two subfield groups S and two subfield groups A is as follows.

As shown in FIG. 7, a light emitting in sequential subfields occurs to the subfield groups S more often than to the subfield groups A. As a result, the peak of luminance tends to occur in each subfield group S.

When the image update rate is 50 frames per second, it often happens that two peaks appear in one field. When this happens, the apparent image update rate becomes 100 frames per second, with which humans do not feel the flickering on the screen.

The number of provided gray scale levels increases by adding two subfield groups A to one field. That is to say, the number of provided gray scale levels is small when one field has only subfield groups S.

The maximum number of gray scale levels that can be represented by one subfield group S is obtained by adding “1” to the number of subfields constituting the subfield group S, while the maximum number of gray scale levels that can be represented by one subfield group A is obtained by adding “1” to 2^{(1-J)}, where “J” indicates the number of subfields constituting the subfield group A.

For example, if a subfield group S and a subfield group A have 4 subfields each, then the maximum number of available gray scale levels is 5 and 9, respectively. That means the subfield group A has 4 available gray scale levels more than the subfield group S.

(3) The reason why a subfield group S is always followed by a subfield group A is as follows.

In the STCE driving method based on the positive logic writing, the light emitting in each subfield group S concentrates in the latter half. Accordingly, if a subfield group A is always followed by a subfield group S, a time interval is often generated between light emitting in the subfield group A and light emitting in the succeeding subfield group S. This causes the light emitting to occur intermittently, resulting in the occurrence of “moving image false edge”.

The setting (3) is therefore made to prevent the problem. (4) Even if one field has two subfield groups S, it is impossible to cause two peaks to appear in one field if the light emitting is lopsided toward either of the two subfield groups S, especially in the expression of low gray scale levels.

Accordingly, to ensure that two peaks appear in one field for each gray scale level, it is necessary to evenly assign luminance weights to the two subfield groups S in one field, as shown in FIG. 7.

The setting (4) is made for this reason. (5) The setting (5) is made to cause the two peaks of luminance in one field to occur with a certain time interval in between.

If the two peaks of luminance occur with a short time interval in between, human eyes often recognize them as one peak of luminance. When this happens, humans feel a flickering on the screen since the apparent image update rate does not increase.

By making the setting (5), allowing the time interval between the two subfield groups S (from the start to the start, or from the end to the end) to be in the above-stated range, it is assured that the two peaks of luminance in one field occur with enough time interval in between to let human eyes recognize two luminance peaks, preventing the occurrence of flickering.

It should be noted here that the above-stated range for the time interval between the two subfield groups S was obtained empirically.

(6) The setting (6) is made so that as the gray scale level increases, the increases in the luminance peak values in the first and latter subfield groups S keep pace with each other.

As the luminance peak value increases in either of the two subfield groups S, humans tend to feel difficult in recognizing the luminance peak value in the other subfield group S. To ovoid this, the arrangement is made so that the increase in the luminance peak value occurs alternately between the two subfield groups S. This prevents the increase in the luminance peak value from being lopsided toward either of the subfield groups S, preventing the flickering.

(7) In each subfield group S in the STCE driving method based on the positive logic writing, the rate of light emitting increases as the subfield proceed since once a light emitting occurs the light emitting is continued for the rest of the subfields. Accordingly, the number of available gray scale levels increases by making the setting (7).

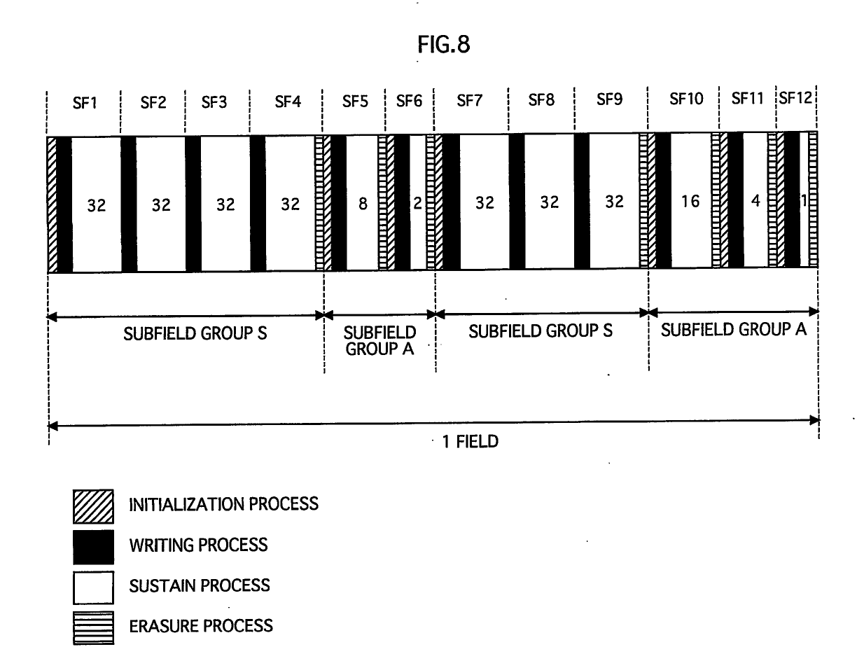

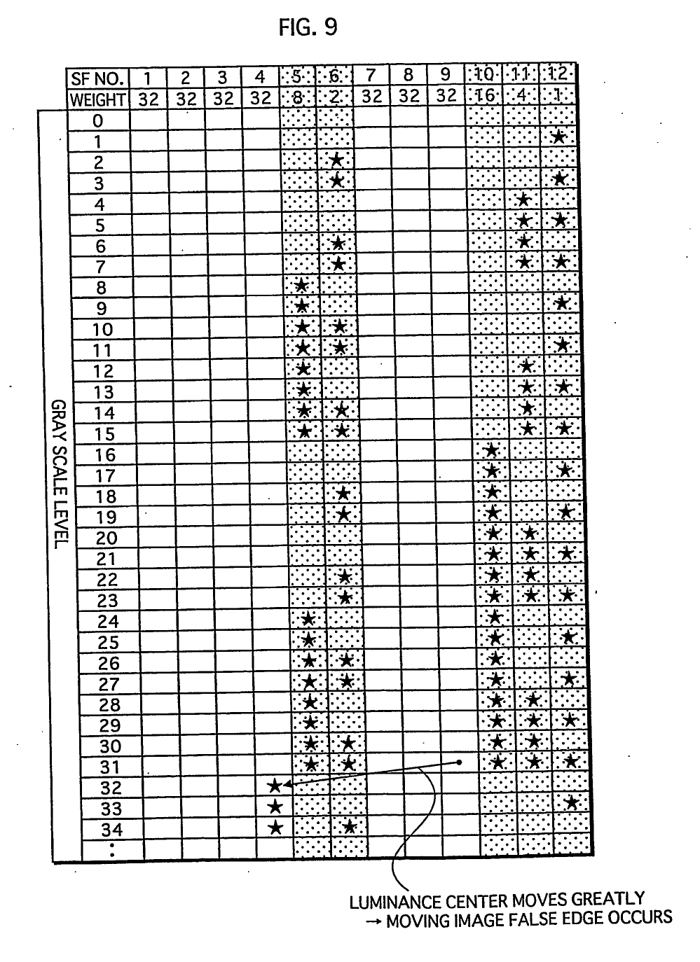

(8) FIG. 8 shows an example of a field for which the setting (8) has not been made. FIG. 9 shows a light emitting pattern for the low gray scale levels, for which the flickering problem rarely occurs, with the same luminance weights assignment as that shown in FIG. 8. As understood from FIG. 9, when the screen is displayed by gradually increasing the gray scale level starting with the lowest gray scale level, the center of luminance often moves greatly since light is often emitted alternately between the two subfield groups A, where the luminance center refers to the equilibrium point of luminance in one field in the time domain. This tends to cause the moving image false edge.

For example, suppose that in a field, light is emitted in a subfield (point A in the time axis) with luminance weight “3”, then after a certain time period, light is emitted in another subfield (point B in the time axis) with luminance weight “1”. In this case, the luminance center is a point between the point A and point B, where lengths from this point to the point A and the point B are in a ratio of “1:3”.

By making the setting (8), the light emitting is gradually shifted from SF12 toward SF10 and from SF6 to SF5 as the gray scale level increases. This reduces the occurrence of the moving image false edge in the display of low gray scale levels (levels 0-31).

(9) When the screen is displayed by gradually increasing the gray scale level starting with the lowest gray scale level, light is emitted only in the subfield groups A for the first certain number of serial gray scale levels, then light is emitted also in a subfield group S. Here, if the luminance weight assigned to the minimum subfield S is larger than the total of the luminance weights assigned to all the subfield groups A, then a logical conclusion is that when light is emitted in a subfield group S for the first time in the above case, light is emitted in the minimum subfield S and no light emission is performed in any subfields in the subfield groups A.

In other words, it is a shift from a stage 1 to a stage 2, where in the stage 1, light is emitted in a plurality of subfields in the subfield groups A, that is, light is emitted intermittently a plurality of times, and in the stage 2, light is emitted only in the minimum subfield S in a subfield group S.

On the other hand, if the luminance weight assigned to the minimum subfield S is no higher than “2^{L}−1”, that is, the total of the luminance weights assigned to subfields of all the subfield groups A, then, when light is emitted in a subfield group S for the first time in the above case, there may be a case where light is emitted in the minimum subfield S and in one or more subfields in the subfield groups A.

This case will be referred to as a shift from the stage 1 to a stage 3, in which light is emitted in the minimum subfield S and in one or more subfields in the subfield groups A.

Here, a comparison is made focusing the luminance center between the shift from the stage 1 to the stage 2 and the shift from the stage 1 to the stage 3. Then, it will be apparent that the luminance center more moves in the shift from the stage 1 to the stage 2 than in the shift from the stage 1 to the stage 3, as shown in FIG. 7. This is because the stage 3 includes part of the light-emitting subfields of the stage 1.

In the example shown in FIG. 7, the luminance center for the gray scale level 32 is in SF5. Suppose here that the luminance weight assigned to SF4 is “32” instead of “8”, then the luminance center for the gray scale level 32 will be in SF4. This means that the luminance center moves more.

The less the luminance center moves, the lower the chance of occurrence of the moving image false edge is. As a result, the setting (9) is made to reduce the amount of movement of the luminance center.

(10) The reason for the setting (10) is the same as that for the setting (9).

When the maximum subfield A is SF10 and the minimum subfield S is SF4 as shown in FIG. 9, the luminance center is approximately in SF9 in the stage 1. In contrast, when the maximum subfield A is SF5 and the minimum subfield S is SF4 as shown in FIG. 7, the luminance center is approximately in SF7 in the stage 1, which is nearer to the luminance center (SF5) in the stage 3 than SF9 in the case of FIG. 9.

With this arrangement, the luminance center moves less as the display shifts from the stage 1 to the stage 3. This further suppresses the occurrence of the moving image false edge.

As described above, the plasma display panel driving method of the present embodiment improves the image quality by providing the above-described settings (1) to (10) for the following effects: (a) the number of available gray scale levels is increased by incorporating subfield groups A based on the ADS driving method, making up the shortage of gray scale levels that are available when one field includes only subfield groups S based on the STCE driving method; (b) occurrence of flickering is suppressed since the peak of luminance tends to occur in each of the two subfield groups S, doubling the apparent image update rate; and (c) occurrence of moving image false edge is suppressed since the luminance center moves less.

In the present embodiment, one field contains two subfield groups S. However, one field may contain three or more subfield groups S. This will be an effective countermeasure against the flickering when the image update rate (number of frames/second) is very low.

When the above variation is applied, the setting (5) should be changed as follows, for example.

When one field consists of F (a natural number no lower than 2) subfield groups S and M (a natural number no lower than 1) subfield groups A, the time interval between the two subfield groups S (from the start to the start, or from the end to the end) is in a range from (a) “(the time period of one field)×1/F×0.9” to (b) “(the time period of one field)×1/F×1.1”.

In the following description, the above setting is referred to as (5)-A.

In the present embodiment, one field contains two subfield groups A. However, not limited to this number, one field may contain one or more subfield groups A.

When one field contains one subfield group A, subfield groups in one field will be arranged as S-A-S.

In the present embodiment, one field contains 12 subfields. However, the number of subfields in one field is not limited to this number.

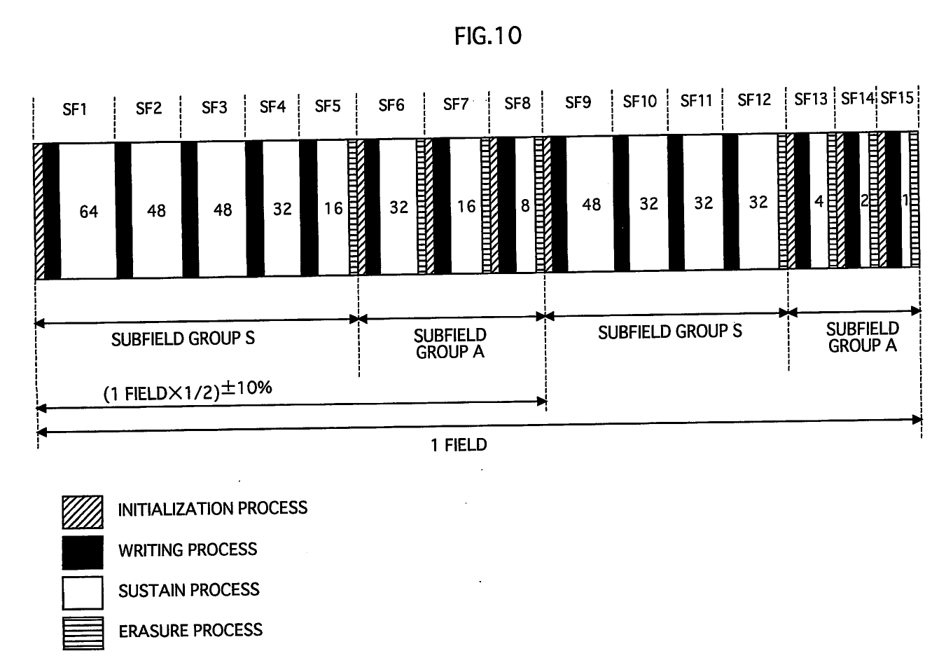

For example, as shown in FIG. 10, one field may contain 15 subfields. In this example, groups of consecutive subfields SF1 to SF5 and SF9 to SF12 are subfield groups S, and groups of consecutive subfields SF6 to SF8 and SF13 to SF15 are subfield groups A.

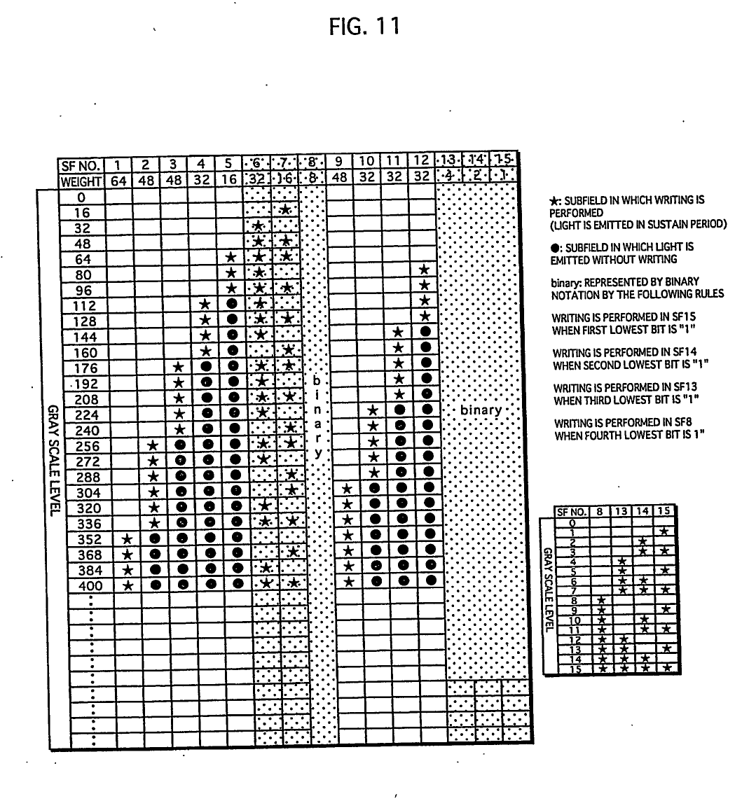

The subfields SF1 to SF15 are assigned luminance weights 64, 48, 48, 32, 16, 32, 16, 8, 48, 32, 32, 32, 4, 2, 1, respectively. As shown in FIG. 11, such construction of the subfields in one field provides gray scale levels “0”-“415” by ensuring a balance between luminance weights assigned to the two subfield groups S, and suppresses the occurrence of the flickering and the moving image false edge, as described in the present embodiment.

In FIG. 10, it is shown that the time interval between the start of the first subfield group S and the start of the latter subfield group S is in a range from (a) “(the time period of one field)×½×0.9” to (b) “(the time period of one field)×1/2×1.1”. However, the time interval between the end of the first subfield group S and the end of the latter subfield group S may be in a range from (a) “(the time period of one field)×½×0.9” to (b) “(the time period of one field)×½×1.1”.

In the present embodiment, all of the settings (1) to (10) are adopted. However, the setting (1) plus at least one of the settings (2) to (10) may be adopted, where the setting (5) may be replaced with the setting (5)-A.

The plasma display panel driving method in the present embodiment is effective in preventing the occurrence of flickering in image displays based on the PAL video standard that defines a low image update rate (number of frames per second). However, the driving method may be used in image displays based on the NTSC video standard or the like.

Embodiment 2

Construction

The plasma display apparatus in Embodiment 2 has the same construction as Embodiment 1 shown in FIG. 5. Embodiment 2 differs from Embodiment 1 in that the apparatus performs the driving based on the negative logic writing.

Driving Method

The driving method in the present embodiment will be explained here.

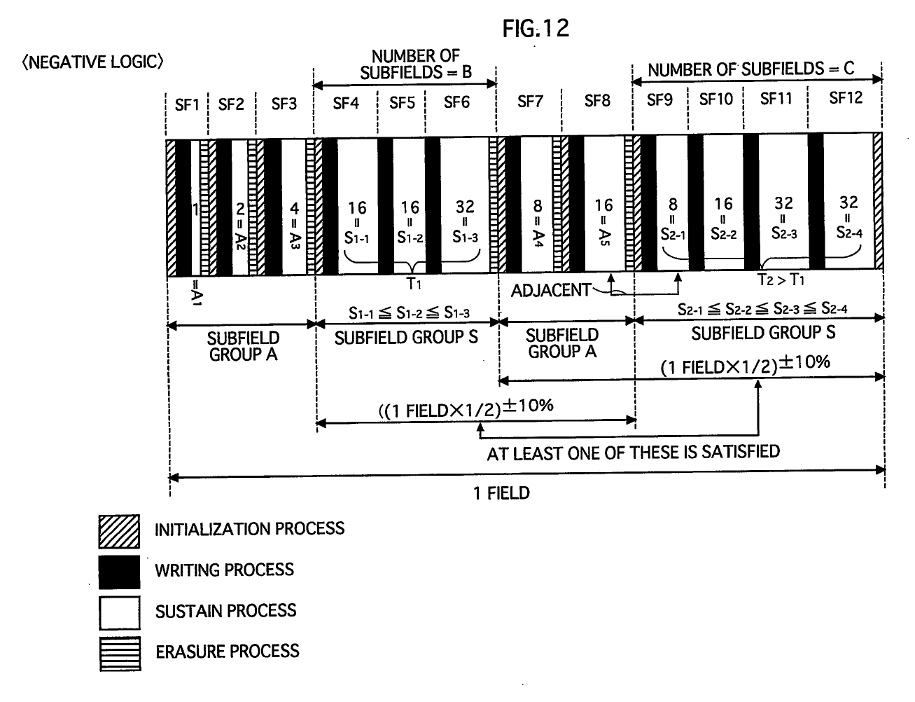

FIG. 12 shows the operation performed in one field by the driving method in the present embodiment.

As shown in FIG. 12, in the present embodiment, one field is divided into 12 subfields (SF1-SF12) in the time domain.

The STCE driving method based on the negative logic writing is applied to SF4-SF6 and SF9-SF12 which are referred to as subfield groups S. That is to say, in each subfield group S, either only one data writing is performed or no data writing is performed. For example, in the case shown in FIG. 12, if a data writing is performed in SFm in the first subfield group S, light is emitted in SF4 through SFm-1 which is immediately before SFm, and light is not emitted in SFm through the last subfield SF6 in the first subfield group S.

If no data writing is performed in a subfield group S, light is emitted in each subfield in the subfield group S.

The latter subfield group S in the set of 12 subfields is similarly controlled.

The ADS driving method is applied to SF1-SF3 and SF7-SF8 which are referred to as subfield groups A. That is to say, in each subfield in the subfield groups A, the initialization, writing, sustain, and erasure processes are performed, as is the case with the positive logic writing.

Luminance weights of 1, 2, 4, 16, 16, 32, 8, 16, 8, 16, 32, 32 are respectively assigned to SF1 to SF12, providing 183 gray scale levels.

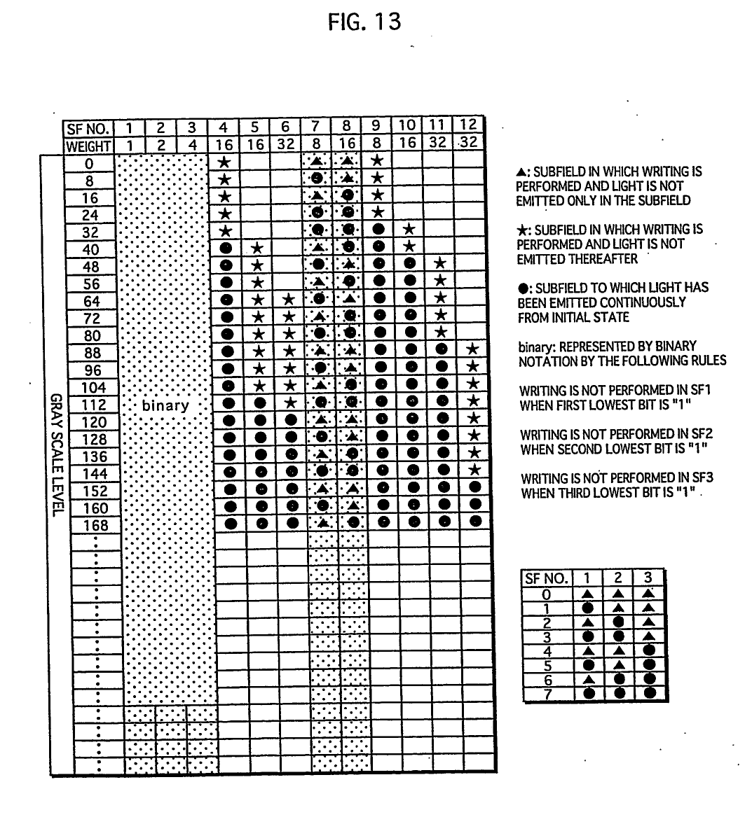

FIG. 13 shows an example of the conversion table stored in the subfield converting unit 370 for the STCE driving and ADS driving.

In FIG. 13, the mark black star indicates that the writing is performed, the black circle indicates that the light has been emitted continuously from initial state, which is unique to the STCE driving method, and the black triangle indicates that in the subfield, writing is performed and light is not emitted only in the subfield.

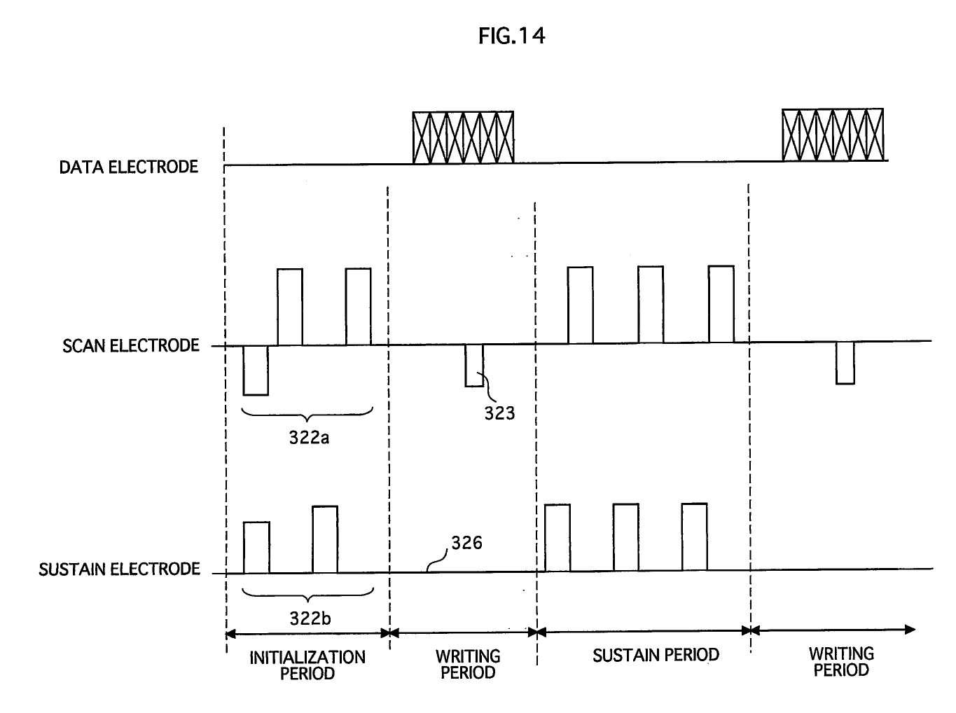

FIG. 14 shows waveforms of voltages applied by the STCE driving method based on the negative logic writing, to the scan electrodes 101, sustain electrodes 102, and data electrodes 103.

The STCE driving method based on the negative logic writing differs from the STCE driving method based on the positive logic writing in that in the initialization period, a voltage pulse 322a whose starting portion has the negative polarity and the rest has the positive polarity is applied to each of the scan electrodes 101, and that a positive-polarity voltage pulse 322b is applied to each of the sustain electrodes 102.

Furthermore, STCE driving method based on the negative logic writing differs from the STCE driving method based on the positive logic writing in that in the writing period, no voltage is applied to the sustain electrodes 102, and only a negative-polarity voltage pulse 323 is applied only to a scan electrode 101 that corresponds to a cell for which light emitting is to be stopped.

The driving method of the present embodiment is characterized by the respective numbers of subfield groups S and A in a field and the arrangement thereof, and also by the number of subfields for each subfield group, and a relative luminance ratio, that is, how the luminance weights are assigned to the subfields.

The following describes such settings in detail.

Settings

(1) All subfields are driven based on the negative logic writing.

(2) One field contains two subfield groups S and two subfield groups A.

(3) A subfield group A is always followed by a subfield group S.

(4) When there are a plurality of combinations of subfields in terms of the two subfield groups S for a certain gray scale level in the condition that the writing state of the two subfield groups A should not be not changed, a combination of subfields is selected among them so that a difference between (i) the total of luminance weights of the ON subfields (in which light is emitted) in one of the two subfield groups S and (ii) the total of luminance weights of the ON subfields in the other is the smallest.

For example, in the case shown in FIG. 13, to display a gray scale level “40”, light may be emitted in SF10 instead of SF4 since they are assigned the same luminance weight. However, according to the setting (4), the difference between the total luminance weights of ON subfields in two subfield groups S (in this case, a subfield group S containing SF4-SF6 and a subfield group S containing SF9-SF12) should be the smallest. As a result, the combination, shown in FIG. 13, of subfields for the gray scale level “40” is selected.

(5) The time interval between the two subfield groups S (from the start to the start, or from the end to the end) is in a range from (a) “(the time period of one field)×½×0.9” to (b) “(the time period of one field)×½×1.1”.

The setting (5) in the present embodiment is made possible for the same reason as in Embodiment 1. That is to say, although not illustrated, there exists a “non-operation” period between each pair of adjacent subfields. In general, each pair of adjacent subfields has an evenly assigned non-operation period in between. However, in the present embodiment, the non-operation period is determined for each pair of adjacent subfields to achieve the above setting of time interval between two consecutive subfield groups S.

Also, for the same reason as in Embodiment 1, there is enough total length of the non-operation periods to ensure that the time interval between the two subfield groups S is in the above-stated range.

(6) The difference in the number of subfields between the two subfield groups S is no more than “1”.

(7) In each subfield group S, a luminance weight assigned to a subfield is equal to or larger than that assigned to a subfield immediately before.

(8) The luminance weight assigned to the first subfield in all the subfield groups A is “1”, and a luminance weight assigned to the k^{th} subfield is “2 raised to the (k−1)^{th} power”.

Here, a subfield having a value L being the maximum value of k is referred to as “maximum subfield A”.

(9) The minimum luminance weight among the luminance weights assigned to the subfields of all the subfield groups S is no higher than “2^{L}−1”, which is the total of the luminance weights assigned to subfields of all the subfield groups A.

Here, a subfield in the subfield groups S to which the minimum luminance weight is assigned is referred to as “minimum subfield S”.

When there are a plurality of subfields to which the minimum luminance weight is assigned in the subfield groups S, the minimum subfield S is a subfield in which light is emitted first in the subfield groups S when the displayed gray scale level is increased starting with the lowest gray scale level.

(10) The minimum subfield S is adjacent to the maximum subfield A in each set of subfields constituting one field.

More particularly, in the example shown in FIG. 12, SF9 (minimum subfield S) to which luminance weight S₂₋₁ is assigned is adjacent to SF8 (maximum subfield A) to which luminance weight A₅ is assigned.

Now, the present driving method will be explained in detail by referring to the reason for the above settings (1) to (10).

Reason for Settings

(1) A driving based on the negative logic writing is a prerequisite for the present embodiment.

(2) The setting (2) for the negative logic writing is made for the same reason as for the setting (2) for the positive logic writing, to suppress the occurrence of flickering.

(3) The reason why a subfield group A is always followed by a subfield group S is as follows.

In the STCE driving method based on the negative logic writing, the light emitting in each subfield group S concentrates in the first half. Accordingly, if a subfield group S is always followed by a subfield group A, a time interval is often generated between light emitting in the subfield group S and light emitting in the succeeding subfield group A. This causes the light emitting to occur intermittently, resulting in the occurrence of “moving image false edge”.

The setting (3) is therefore made to prevent the problem. (4) The setting (4) for the negative logic writing is made for the same reason as for the setting (4) for the positive logic writing, to suppress the occurrence of flickering.

(5) The setting (5) for the negative logic writing is made for the same reason as for the setting (5) for the positive logic writing, to suppress the occurrence of flickering.

(6) The setting (6) for the negative logic writing is made for the same reason as for the setting (6) for the positive logic writing, to suppress the occurrence of flickering.

(7) In each subfield group S in the STCE driving method based on the negative logic writing, the rate of light emitting decreases as the subfield proceed. Accordingly, the number of available gray scale levels increases by making the setting (7).

(8) The setting (8) for the negative logic writing is made for the same reason as for the setting (8) for the positive logic writing, to suppress the occurrence of moving image false edge.

(9) The setting (9) for the negative logic writing is made for the same reason as for the setting (9) for the positive logic writing, to suppress the occurrence of moving image false edge.

(10) The setting (10) for the negative logic writing is made for the same reason as for the setting (10) for the positive logic writing, to suppress the occurrence of moving image false edge.

As described above, the plasma display panel driving method of the present embodiment improves the image quality by providing the above-described settings (1) to (10) for the following effects: (a) the number of available gray scale levels is increased by incorporating subfield groups A based on the ADS driving method, making up the shortage of gray scale levels that are available when one field includes only subfield groups S based on the STCE driving method; (b) occurrence of flickering is suppressed since the peak of luminance tends to occur in each of the two subfield groups S, doubling the apparent image update rate; and (c) occurrence of moving image false edge is suppressed since the luminance center moves less.

In the present embodiment, one field contains two subfield groups S. However, one field may contain three or more subfield groups S. This will be an effective countermeasure against the flickering when the image update rate (number of frames/second) is very low.

When the above variation is applied, the setting (5) should be changed as follows, for example.

When one field consists of F (a natural number of no lower than 2) subfield groups S and M (a natural number of no lower than 1) subfield groups A, the time interval between the two subfield groups S (from the start to the start, or from the end to the end) is in a range from (a) “(the time period of one field)×1/F×0.9” to (b) “(the time period of one field)×1/F×1.1”.

In the following description, the above setting is referred to as (5)-B.

In the present embodiment, one field contains two subfield groups A. However, not limited to this number, one field may contain one or more subfield groups A.

When one field contains one subfield group A, subfield groups in one field will be arranged as A-S-S.

In the present embodiment, one field contains 12 subfields. However, the number of subfields in one field is not limited to this number.

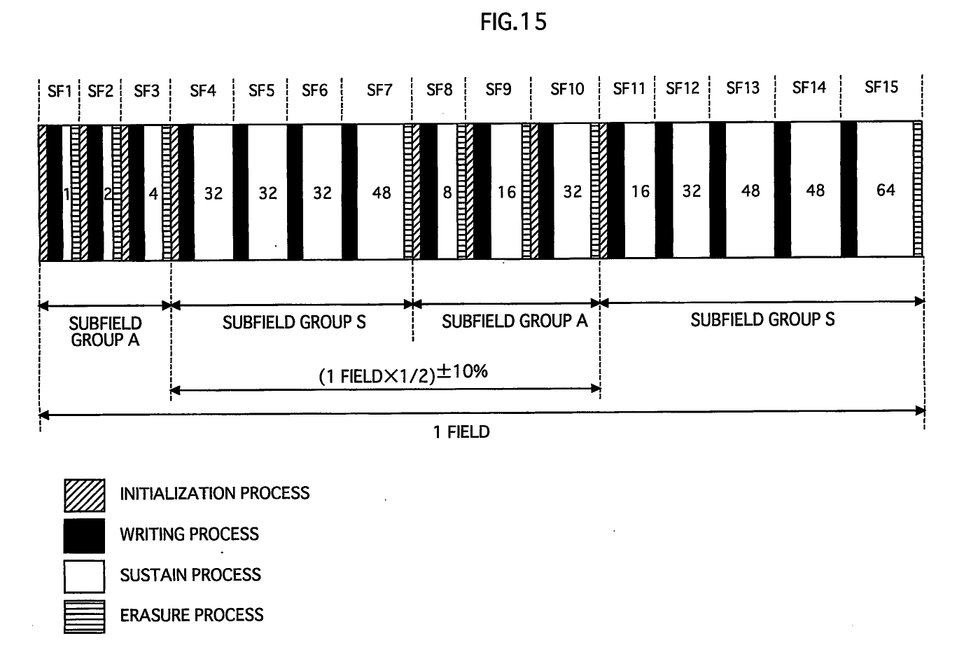

For example, as shown in FIG. 15, one field may contain 15 subfields. In this example, groups of consecutive subfields SF4 to SF7 and SF11 to SF15 are subfield groups S, and groups of consecutive subfields SF1 to SF3 and SF8 to SF10 are subfield groups A.

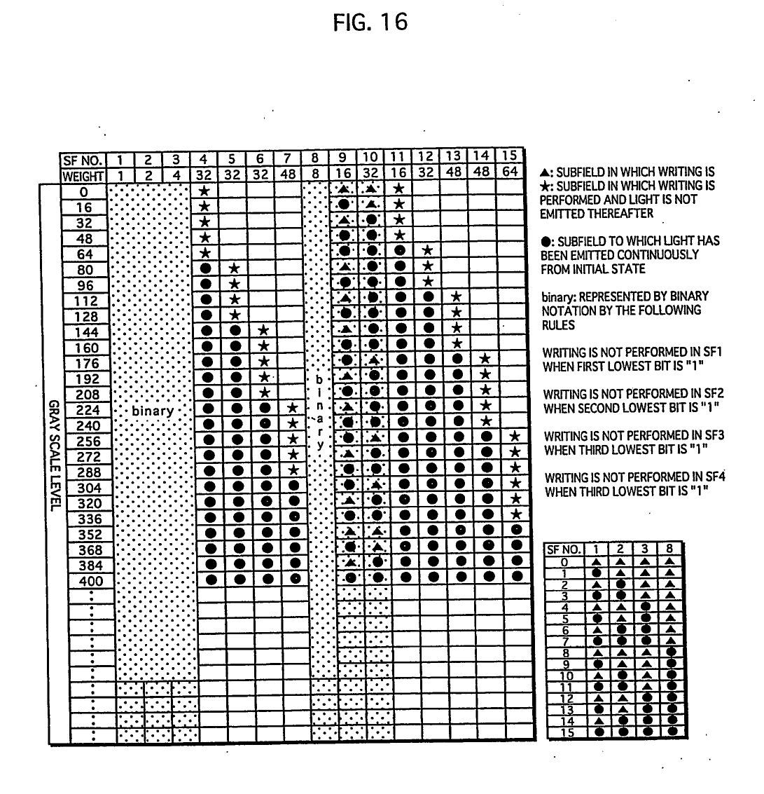

The subfields SF1 to SF15 are assigned luminance weights 64, 48, 48, 32, 16, 32, 16, 8, 48, 32, 32, 32, 4, 2, 1, respectively. As shown in FIG. 16, such construction of the subfields in one field provides gray scale levels “0”-“415” by ensuring a balance between luminance weights assigned to the two subfield groups S, and suppresses the occurrence of the flickering and the moving image false edge, as described in the present embodiment.

In FIG. 15, it is shown that the time interval between the start of the first subfield group S and the start of the latter subfield group S is in a range from (a) “(the time period of one field)×½×0.9” to (b) “(the time period of one field)×½×1.1”. However, the time interval between the end of the first subfield group S and the end of the latter subfield group S may be in a range from (a) “(the time period of one field)×½×0.9” to (b) “(the time period of one field)×1/2X×1.1”.

In the present embodiment, all of the settings (1) to (10) are adopted. However, the setting (1) plus at least one of the settings (2) to (10) may be adopted, where the setting (5) may be replaced with the setting (5)-B.

The plasma display panel driving method in the present embodiment is effective in preventing the occurrence of flickering in image displays based on the PAL video standard that defines a low image update rate (number of frames per second). However, the driving method may be used in image displays based on the NTSC video standard or the like.

### INDUSTRIAL APPLICABILITY

The present invention can be applied to an apparatus for driving a plasma display panel that is used as a display for a television receiver, a personal computer or the like.

1. A plasma display panel driving method for displaying a gray-scale image on a screen by selecting, according to a luminance level of an input image signal, subfields from a set of subfields making up one field in the time domain, and applying a voltage to a cell in a writing period and sustaining a state of the cell in a sustain period in the selected subfields, wherein
one field is divided into F first subfield groups and M second subfield groups, where F is a natural number no lower than 2, and M is a natural number no lower than 1, each subfield group being composed of consecutive subfields,
a time interval between respective starting points or respective ending points of two consecutive first subfield groups is approximately a time period of one field×1/F,
in each first subfield group, a light emitting state of ON or OFF is continued until a writing is performed, after which a reversed light emitting state is kept in each of succeeding sustain periods, and
in each subfield making up the second subfield groups, a light emitting state of ON or OFF is set in a sustain period only when a writing is performed.

2. The plasma display panel driving method of claim 1, wherein
the time interval between respective starting points or respective ending points of two consecutive first subfield groups is in a range from (the time period of one field)×1/F×0.9 to (the time period of one field)×1/F×1.1.

3. The plasma display panel driving method of claim 1, wherein
in each first subfield group, a light emitting state of OFF is continued until a writing is performed, after which a light emitting state of ON is continued in each of succeeding sustain periods,
in each subfield making up the second subfield groups, a light emitting state of ON is set in a sustain period only when a writing is performed, and
at least one first subfield group is followed by a second subfield group.

4. The plasma display panel driving method of claim 3, wherein
the values F and M are equal, and
the subfield groups in the field are arranged repeatedly in an order in which a first subfield group comes first and then a second subfield group comes.

5. The plasma display panel driving method of claim 1, wherein
in each first subfield group, a light emitting state of ON is continued until a writing is performed, after which a light emitting state of OFF is continued in each of succeeding sustain periods,
in each subfield making up the second subfield groups, a light emitting state of OFF is set in a sustain period only when a writing is performed, and
a second subfield group is followed by at least one first subfield group.

6. The plasma display panel driving method of claim 5, wherein
the values F and M are equal, and
the subfield groups in the field are arranged repeatedly in an order in which a second subfield group comes first and then a first subfield group comes.

7. The plasma display panel driving method of claim 1, wherein
a difference in the number of subfields between any pair of first subfield groups is no higher than “1”.

8. The plasma display panel driving method of claim 7, wherein
when there are a plurality of combinations of subfields for a certain gray scale level in terms of the first subfield groups in a condition that a writing state of the second subfield groups should not be changed, a combination of subfields in which totals of luminance weights of ON subfields, in which light is emitted, in respective first subfield groups are most evenly arranged is selected from the plurality of combinations.

9. The plasma display panel driving method of claim 1, wherein
luminance weights assigned to subfields in the first subfield groups are equal, and S subfields are contained in the second subfield groups in one field in total, where S is a natural number no lower than 1, and different luminance weights, each of which is 2 raised to the N^{th} power, where N is a natural number in a range from 0 to S−1 inclusive, are assigned to the S subfields.

10. A plasma display panel driving method for displaying a gray-scale image on a screen by selecting, according to a luminance level of an input image signal, subfields from a set of subfields making up one field in the time domain, and applying a voltage to a cell in a writing period and sustaining a state of the cell in a sustain period in the selected subfields, wherein
one field is divided into F first subfield groups and M second subfield groups, where F is a natural number no lower than 2, and M is a natural number no lower than 1, each subfield group being composed of consecutive subfields,
in each first subfield group, a light emitting state of OFF is continued until a writing is performed, after which a light emitting state of ON is kept in each of succeeding sustain periods,
in each subfield making up the second subfield groups, a light emitting state of ON is set in a sustain period only when a writing is performed,
S subfields are contained in the second subfield groups in one field in total, where S is a natural number no lower than 1, and different luminance weights, each of which is 2 raised to the N^{th} power, where N is a natural number in a range from 0 to S−1 inclusive, are assigned to the S subfields, and in each first subfield group, a luminance weight assigned to a subfield is equal to or smaller than a luminance weight assigned to a subfield immediately before.

11. The plasma display panel driving method of claim 10, wherein
a minimum luminance weight among luminance weights assigned to subfields of at least one first subfield group is no higher than a total of luminance weights assigned to subfields of all the second subfield groups.

12. The plasma display panel driving method of claim 10, wherein
when gray scale is increased gradually starting with the lowest gray scale level, a luminance weight assigned to a subfield in which light is emitted first in the first subfield groups is no higher than a total of luminance weights assigned to light-emitted subfields of a second subfield group before the first light-emitted subfield in the first subfield groups.

13. The plasma display panel driving method of claim 10, wherein
through the second subfield groups in one field, a luminance weight assigned to a subfield is smaller than a luminance weight assigned to a subfield immediately before.

14. The plasma display panel driving method of claim 10, wherein
a first subfield group containing a first subfield is adjacent to a second subfield group containing a second subfield, the first subfield being a subfield in which light is emitted first in the first subfield groups when gray scale is increased gradually starting with the lowest gray scale level, and the second subfield being a subfield to which, among light-emitted subfields of second subfield groups before the first subfield, a largest luminance weight is assigned.

15. The plasma display panel driving method of claim 14, wherein
the first subfield is adjacent to the second subfield.

16. A plasma display panel driving method for displaying a gray-scale image on a screen by selecting, according to a luminance level of an input image signal, subfields from a set of subfields making up one field in the time domain, and applying a voltage to a cell in a writing period and sustaining a state of the cell in a sustain period in the selected subfields, wherein
one field is divided into F first subfield groups and M second subfield groups, where F is a natural number no lower than 2, and M is a natural number no lower than 1, each subfield group being composed of consecutive subfields,
in each first subfield group, a light emitting state of ON is continued until a writing is performed, after which a light emitting state of OFF is kept in each of succeeding sustain periods,
in each subfield making up the second subfield groups, a light emitting state of OFF is set in a sustain period only when a writing is performed,
S subfields are contained in the second subfield groups in one field in total, where S is a natural number no lower than 1, and different luminance weights, each of which is 2 raised to the N^{th} power, where N is a natural number in a range from 0 to S−1 inclusive, are assigned to the S subfields, and in each first subfield group, a luminance weight assigned to a subfield is equal to or greater than a luminance weight assigned to a subfield immediately before.

17. The plasma display panel driving method of claim 16, wherein
a minimum luminance weight among luminance weights assigned to subfields of at least one first subfield group is no higher than a total of luminance weights assigned to subfields of all the second subfield groups.

18. The plasma display panel driving method of claim 16, wherein
when gray scale is increased gradually starting with the lowest gray scale level, a luminance weight assigned to a subfield in which light is emitted first in the first subfield groups is no higher than a total of luminance weights assigned to light-emitted subfields of a second subfield group before the first light-emitted subfield in the first subfield groups.

19. The plasma display panel driving method of claim 16, wherein
through the second subfield groups in one field, a luminance weight assigned to a subfield is greater than a luminance weight assigned to a subfield immediately before.

20. The plasma display panel driving method of claim 16, wherein
a first subfield group containing a first subfield is adjacent to a second subfield group containing a second subfield, the first subfield being a subfield in which light is emitted first in the first subfield groups when gray scale is increased gradually starting with the lowest gray scale level, and the second subfield being a subfield to which, among light-emitted subfields of second subfield groups before the first subfield, a largest luminance weight is assigned.

21. The plasma display panel driving method of claim 20, wherein
the first subfield is adjacent to the second subfield.

22. The plasma display panel driving method of claim 3, wherein
the values F and M are both 2,
the subfield groups in the field are arranged repeatedly in an order in which a first subfield group comes first and then a second subfield group comes, and luminance weights 64, 48, 48, 32, and 16 are assigned in the stated order to five subfields of the first of the two first subfield groups, luminance weights 32, 16, and 8 are assigned in the stated order to three subfields of the first of the two second subfield groups, luminance weights 48, 32, 32, and 32 are assigned in the stated order to four subfields of the second of the two first subfield groups, and luminance weights 4, 2, and 1 are assigned in the stated order to three subfields of the second of the two second subfield groups.

23. The plasma display panel driving method of claim 5, wherein
the values F and N are both 2,
the subfield groups in the field are arranged repeatedly in an order in which a second subfield group comes first and then a first subfield group comes, and luminance weights 1, 2, and 4 are assigned in the stated order to three subfields of the first of the two second subfield groups, luminance weights 32, 32, 32, and 48 are assigned in the stated order to four subfields of the first of the two first subfield groups, luminance weights 8, 16, and 32 are assigned in the stated order to three subfields of the second of the two second subfield groups, and luminance weights 16, 32, 48, 48, and 64 are assigned in the stated order to five subfields of the second of the two first subfield group.

24-25. (Cancelled)

26. The plasma display panel driving method of claim 10, wherein
the values F and M are both 2,
the subfield groups in the field are arranged repeatedly in an order in which a first subfield group comes first and then a second subfield group comes, and luminance weights 64, 48, 48, 32, and 16 are assigned in the stated order to five subfields of the first of the two first subfield groups, luminance weights 32, 16, and 8 are assigned in the stated order to three subfields of the first of the two second subfield groups, luminance weights 48, 32, 32, and 32 are assigned in the stated order to four subfields of the second of the two first subfield groups, and luminance weights 4, 2, and 1 are assigned in the stated order to three subfields of the second of the two second subfield groups.

27. The plasma display panel driving method of claim 16, wherein
the values F and N are both 2,
the subfield groups in the field are arranged repeatedly in an order in which a second subfield group comes first and then a first subfield group comes, and luminance weights 1, 2, and 4 are assigned in the stated order to three subfields of the first of the two second subfield groups, luminance weights 32, 32, 32, and 48 are assigned in the stated order to four subfields of the first of the two first subfield groups, luminance weights 8, 16, and 32 are assigned in the stated order to three subfields of the second of the two second subfield groups, and luminance weights 16, 32, 48, 48, and 64 are assigned in the stated order to five subfields of the second of the two first subfield group.

28. A plasma display panel driving apparatus that drives a plasma display panel for displaying a gray-scale image on a display comprising:
a data determining unit for determining a luminous level of an input image signal;
a subfield converting unit for generating a piece of write subfields specifying data in response to the luminance level wherein one field is divided into F first subfield groups and M second subfield groups, where F is a natural number no lower than 2, and M is a natural number no lower than 1, each subfield group being composed of consecutive subfields;
a display control unit for determining a time interval between respective starting points or respective ending points of two consecutive first subfield groups of approximately a time period of one field×1/F and setting,
in each first subfield group, a light emitting state of ON or OFF is continued until a writing is performed, after which a reversed light emitting state is kept in each of succeeding sustain periods, and
in each subfield making up the second subfield groups, a light emitting state of ON or OFF is set in a sustain period only when a writing is performed; and
a driver unit operatively connected to the display control unit for enabling the display of an image.

29. A plasma display apparatus that comprises:
a plasma display panel; and
a plasma display panel driving apparatus that drives the plasma display panel for displaying a gray-scale image including
a data determining unit for determining a luminance level of an input image signal; and
a subfield converting unit for generating a write-subfields specification data in response to the luminance level wherein one field is divided into F first subfield groups and M second subfield groups, where F is a natural number no lower than 2, and M is a natural number no lower than 1, each subfield group being composed of consecutive subfields,
in each first subfield group, a light emitting state of ON is continued until a writing is performed, after which a light emitting state of OFF is kept in each of succeeding sustain periods,
in each subfield making up the second subfield groups, a light emitting state of OFF is set in a sustain period only when a writing is performed,
S subfields are contained in the second subfield groups in one field in total, where S is a natural number no lower than 1, and different luminance weights, each of which is 2 raised to the N^{th} power, where N is a natural number in a range from 0 to S−1 inclusive, are assigned to the S subfields, and in each first subfield group, a luminance weight assigned to a subfield is equal to or greater than a luminance weight assigned to a subfield immediately before.
